(19) United States
(12) Patent Application Publication
(10) Pub. No.: US 2005/0051007 A1
(43) Pub. Date: Mar. 10, 2005

(54) Universal slicer with positioning plate

(75) Inventors: Peter Kovacic, Gomilsko (SI); Jozef Skoncnik, Recica (SI)

Correspondence Address: LERNER AND GREENBERG, PA, P O BOX 2480, HOLLYWOOD, FL, 33022-2480, US

(73) Assignee: BSH Bosch und Siemens Hausgerate GmbH

(21) Appl. No.: 10/928,225

(22) Filed: Aug. 27, 2004

Related U.S. Application Data
(63) Continuation of application No. PCT/EP03/01810, filed on Feb. 21, 2003.

(30) Foreign Application Priority Data
Feb. 27, 2002 (DE) 102 08 493.9

(51) Int. Cl. B26D 7/06

(52) U.S. Cl. 83/167; 83/707; 83/478; 83/571

(57) ABSTRACT

A universal slicer contains a housing, a rotatably mounted revolving blade, a positioning plate which is provided with a bearing surface for a product that is to be sliced, and a mechanism regulating the width of cut by adjusting the positioning plate in relation to the revolving blade. In order to ensure that the slices are cut in a uniform manner, particularly when using universal slicers that have a simple configuration and are inexpensive to produce, the universal slicer is provided with a tensioning device, by which the positioning plate can be prestressed free from play counter to the mechanism regulating the width of cut.

### CROSS-REFERENCE TO RELATED APPLICATION

This application is a continuation, under 35 U.S.C. § 120, of copending international application No. PCT/EP03/01810, filed Feb. 21, 2003, which designated the United States; this application also claims the priority, under 35 U.S.C. § 119, of German patent application No. 102 08 493.9, filed Feb. 27, 2002; the prior applications are herewith incorporated by reference in their entirety.

### BACKGROUND OF THE INVENTION

1. Field of the Invention

The invention relates to a universal slicer having a housing, a rotatably mounted round blade, and a positioning plate which has a bearing surface for an item for slicing. A slicing-width adjustment mechanism is provided for adjusting the positioning plate in relation to the round blade. Universal slicers with a housing and a round blade mounted rotatably therein, up against which an item for slicing bearing against a positioning plate can be brought, are known. The known universal slicers have a plane positioning plate which can be adjusted in relation to the round blade by a slicing-width adjustment mechanism. The position of the positioning plate in relation to the round blade defines the width of the slice of the item for slicing cut off. In general, the slicing-width adjustment mechanism contains a threaded portion which engages in an associated threaded portion on the positioning plate.

It is a disadvantage of the known universal slicers that the positioning plate has relatively great play in relation to the slicing-width adjustment mechanism. Owing to the great play between the positioning plate and the slicing-width adjustment mechanism, the bearing surface of the positioning plate is positioned only roughly. If an item for slicing is placed against the bearing surface of the positioning plate and the item for slicing is moved along the bearing surface toward the round blade, a change in position of the bearing surface of the positioning plate may occur. If a change in position occurs during the slicing operation, slices of varying thickness are produced.

### SUMMARY OF THE INVENTION

It is accordingly an object of the invention to provide a universal slicer with a positioning plate which overcomes the above-mentioned disadvantages of the prior art devices of this general type, which produces slices of uniform thickness. The uniformity of the slices is in particular also to be guaranteed in universal slicers that are of a simple configuration and/or inexpensive to manufacture.

With the foregoing and other objects in view there is provided, in accordance with the invention, a universal slicer. The slicer contains a housing, a round blade rotatably mounted in the housing, a positioning plate having a bearing surface for an item for slicing and mounted in the housing, a slicing-width adjustment mechanism for adjusting the positioning plate in relation to the round blade, and a tensioner for prestressing the positioning plate free of play against the slicing-width adjustment mechanism.

By virtue of the tensioning device, by way of which the positioning plate can be prestressed free of play against the slicing-width adjustment mechanism, being provided on the universal slicer, it is ensured that the bearing surface for the item for slicing has a position that no longer changes during the slicing operation. In plastic universal slicers in particular, the positioning plate is adjusted by two mutually engaging threaded portions via a slicing-width adjustment mechanism. The slicing-width adjustment mechanism can comprise a rotatable handle. By rotating the handle, the positioning plate is displaced in relation to the round blade. In order that a clear adjustment travel is achieved on the positioning plate with only a small angular rotation of the handle, the threaded portion on the slicing-width adjustment mechanism is provided with a large thread pitch. The large thread pitch makes it necessary for the mutually engaging threaded portions of the slicing-width adjustment mechanism and of the positioning plate to have relatively great play. Only in this way can the positioning plate be adjusted by the rotatable handle with little effort. In universal slicers of this kind, the disadvantage of mounting the positioning plate with great play proves to be especially great.

In one embodiment of the invention, separate elastic spring elements can be provided inside the housing of the universal slicer, which prestress the positioning plate against the slicing-width adjustment mechanism. Preferably, at least two spring elements are provided, the first ends of which act on the rear side of the positioning plate and the second ends of which are supported against an inner side of the housing. The positioning plate is canted in relation to the slicing-width adjustment mechanism by the elastic spring elements. Owing to the canting, play-free prestressed positioning of the positioning plate is brought about.

In a preferred embodiment of the invention, the positioning plate has a bearing surface which, in proximity to its edge facing the round blade, has at least one raised portion protruding in relation to the remaining bearing surface. In this preferred embodiment, the advantage is obtained that separate elastic spring elements can be dispensed with and prestressing of the positioning plate is nevertheless achieved. This is because when the item for slicing is placed against the bearing surface of the positioning plate, a force acting perpendicularly to the bearing surface is generated by the user. At the beginning of the slicing operation, the user pushes the item for slicing in the direction of the round blade. The item for slicing bearing against the bearing surface of the positioning plate is therefore displaced in the direction of the round blade on the bearing surface. Before the item for slicing reaches the periphery of the round blade, it has to surmount the protruding raised portion in the bearing surface. If the item for slicing is moved against the protruding raised portion, a force is introduced into the positioning plate at the protruding raised portion, which generates a torque that is introduced into the positioning plate and cants or prestresses the latter in relation to the slicing-width adjustment mechanism. In this way, the positioning plate is intentionally moved into a canted position before the item for slicing has reached the periphery of the round blade. For a uniform width of the item for slicing, it is not necessary to align the plane of the bearing surface parallel to the plane of the round blade. For a uniform width of the slice, it is necessary only that that edge of the bearing surface of the positioning plate facing the round blade does not change its spatial position throughout the slicing operation. If the bearing surface of the positioning plate is already prestressed by the protruding raised portion according to the invention at the beginning of the slicing operation, the positioning plate can no longer reposition itself during the slicing operation. It is consequently ensured that that edge of the bearing surface of the positioning plate facing the round blade does not change its position during the slicing operation.

In one embodiment of the invention, the protruding raised portion can be formed by a plurality of raised portions that are distributed uniformly over the entire length of that edge of the bearing surface of the positioning plate facing the round blade. The known positioning plates of plane configuration mainly have a surface structure that prevents the item for slicing bearing against the positioning plate over a large area. The intention of this is that the item for slicing will bear against the positioning plate in only a few surface portions, so that the item for slicing adheres only slightly on the bearing surface of the positioning plate and can easily be moved toward the round blade. If a positioning plate with a surface structure is used in a universal slicer according to the invention, the raised portions according to the invention can be configured correspondingly. If the bearing surface of the positioning plate has, for example, a plurality of horizontally running grooves, the protruding raised portion can then have a corresponding number of horizontally running grooves which are distributed along that edge of the bearing surface facing the round blade and are raised in relation to the plane of the remaining bearing surface. This has the advantage that the item for slicing placed on the surface can be moved toward the round blade with little effort in the region of the protruding raised portions as well.

In a preferred embodiment, the protruding raised portion has a plateau portion which adjoins the edge facing the round blade and has a slope portion which is disposed between the plateau portion and the remaining bearing surface. The plateau portion ensures to a particular degree that the positioning plate is completely prestressed before the item for slicing reaches the periphery of the round blade.

In order to achieve sufficient prestressing effect by the protruding raised portion and at the same time to give the bearing surface of the positioning plate an attractive appearance, the plateau portion can be configuration in such a way that it is raised from the plane of the remaining bearing surface by between 0.5 and 2 mm.

That edge of the bearing surface of the positioning plate facing the round blade has a circular-arc-shaped configuration and the plateau portion can accordingly extend with a constant width along the circular-arc-shaped edge. This ensures that items for slicing of very different cross section or very different size can be processed by the universal slicer according to the invention and the prestressing function is achieved both with items for slicing of very small diameter and with items for slicing of very large diameter. In an advantageous embodiment of the protruding raised portion, the plateau portion has a width of between 10 and 20 mm.

Other features which are considered as characteristic for the invention are set forth in the appended claims.

Although the invention is illustrated and described herein as embodied in a universal slicer with a positioning plate, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective view of a universal slicer according to the invention; and

FIG. 2 is a diagrammatic, cross-sectional view through a part of the universal slicer according to the invention according to FIG. 1.

### DESCRIPTION OF THE PREFERRED EMBODIMENTS

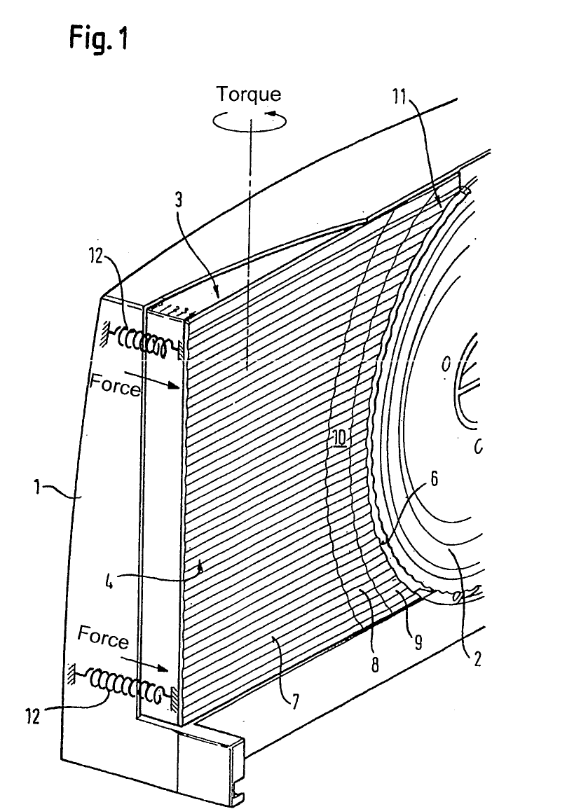

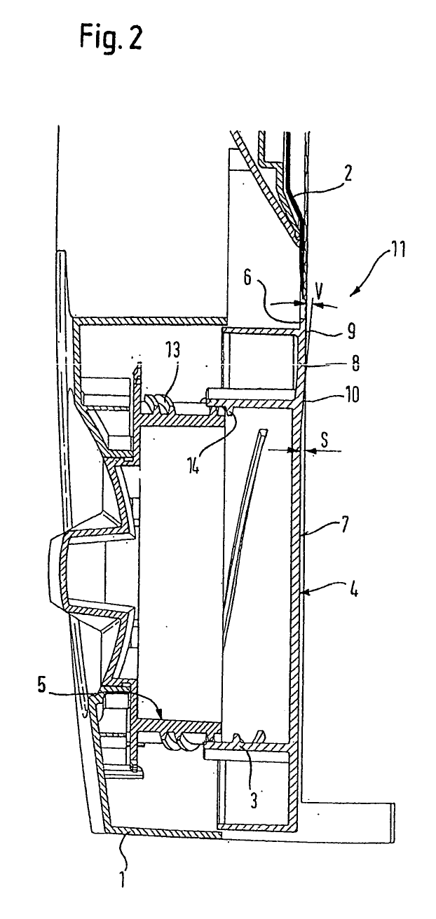

Referring now to the figures of the drawing in detail and first, particularly, to FIG. 1 thereof, there is shown a universal slicer having a housing 1 in which a round blade 2 is rotatably mounted. The universal slicer has a positioning plate 3 that is mounted adjustably in the housing 1 in relation to the round blade 2. An adjustment of the positioning plate 3 is effected by a slicing-width adjustment mechanism 5 (see FIG. 2). The positioning plate 3 has a bearing surface 4 that has horizontally running grooves. At an edge 6 of the bearing surface 4 facing the round blade 2, a raised portion 8 extends in a circular-arc shape. The circular-arc-shaped raised portion 8 contains a plateau portion 9 adjoining an edge 6. Disposed between the plateau portion 9 and a remaining bearing surface 7 of the bearing surface 4 is a slope portion 10. The slope portion 10 forms the transition from the surface of the plateau portion 9 to the plane of the remaining bearing surface 7. In a similar way to the horizontally running grooves of the remaining bearing surface 7 of the positioning plate 3, both the plateau portion 9 and the slope portion 10 have horizontally running grooves. As an alternative configuration of the tensioning device according to the invention, separate tensioning devices 12, which prestress the positioning plate in the housing 1 free of play, can be provided instead of the protruding raised portion 8 formed of the plateau portion 9 and the slope portion 10. In this connection, an elastic tensioning device 12 can in each case act on an edge of the positioning plate 3 opposite the round blade. One end of each elastic tensioning device 12 is then preferably in contact with an inner surface of the positioning plate 3. The second ends of the elastic tensioning device 12 are supported on an inner side of the housing 1.

FIG. 2 shows the cross section through a part of the universal slicer according to the invention according to FIG. 1. The slicing-width adjustment mechanism 5 is mounted rotatably in the housing 1. The slicing-width adjustment mechanism 5 has a threaded portion 13 on its side facing the positioning plate 3. The threaded portion 13 is in engagement with a further threaded portion 14 formed on the positioning plate 3. The positioning plate 3 has the bearing surface 4. The bearing surface 4 is disposed on that side of the housing 1 which also bears the round blade 2. The bearing surface 4 has the plateau portion 9 that is raised in relation to the remaining bearing surface 7 by a height S. Located between the plateau portion 9 and the remaining bearing surface 7 is the slope portion 10 which is inclined at an angle V to a plane of the remaining bearing surface 7. The threaded portion 13 of the slicing-width adjustment mechanism 5 and the threaded portion 14 on the positioning plate 3 have as large a diameter as possible, the size of which is adapted to the bearing surface 4 of the positioning plate 3. The protruding raised portion 8, which bears the plateau portion 9 and the slope portion 10, is disposed in a region of the bearing surface 4 which is disposed outside an outside diameter of the threaded portions 13 and 14.

This application claims the priority, under 35 U.S.C. § 119, of German patent application No. 102 08 493.9, filed Feb. 27, 2002; the entire disclosure of the prior application is herewith incorporated by reference.

1. A universal slicer, comprising:
a housing;
a round blade rotatably mounted in said housing;
a positioning plate having a bearing surface for an item for slicing and mounted in said housing;
a slicing-width adjustment mechanism for adjusting said positioning plate in relation to said round blade; and
a tensioner for prestressing said positioning plate free of play against said slicing-width adjustment mechanism.

2. The universal slicer according to claim 1, wherein said bearing surface has an edge and in proximity to said edge facing said round blade, has at least one raised portion protruding in relation to a remaining surface of said bearing surface.

3. The universal slicer according to claim 2, wherein said raised portion is one of a plurality of raised portions distributed uniformly over an entire length of said edge facing said round blade.

4. The universal slicer according to claim 2, wherein said raised portion extends over an entire length of said edge facing said round blade.

5. The universal slicer according to claim 2, wherein said raised portion has a plateau portion adjoining said edge and a slope portion disposed between said plateau portion and said remaining surface.

6. The universal slicer according to claim 5, wherein said plateau portion is raised from a plane of said remaining surface by 0.5 to 2 mm.

7. The universal slicer according to claim 5, wherein said edge is a circular-arc-shaped edge and said plateau portion extends with a constant width along said circular-arc-shaped edge.

8. The universal slicer according to claim 7, wherein said plateau portion has a width between 10 and 20 mm.
